(19) United States
(12) Patent Application Publication
(10) Pub. No.: US 2017/0124077 A1
(43) Pub. Date: May 4, 2017

(54) FLASH MODULE PROVIDED WITH DATABASE OPERATION UNIT, AND STORAGE DEVICE

(71) Applicant: Hitachi, Ltd., Tokyo (JP)

(72) Inventors: Satoru WATANABE, Tokyo (JP); Akira YAMAMOTO, Tokyo (JP); Yoshiki KUROKAWA, Tokyo (JP); Yoshitaka TSUJIMOTO, Tokyo (JP)

(21) Appl. No.: 15/129,489

(22) PCT Filed: Apr. 24, 2014
(86) PCT No.: PCT/JP2014/061560

§ 371 Date: Sep. 27, 2016

(51) Int. Cl. G06F 17/30; G06F 12/0802; G06F 12/1009; G06F 3/06

(52) U.S. Cl. CPC G06F 17/3048; G06F 3/0611; G06F 3/0659; G06F 3/0688; G06F 12/0802; G06F 12/1009; G06F 2212/222; G06F 2212/60; G06F 2212/7201

(57) ABSTRACT

A storage apparatus to be coupled to a network, the storage apparatus comprising: a controller; and a storage medium to be coupled to the controller, the storage medium comprising one or more flash modules each comprising a database operation module, the controller being configured to receive a database operation command, and to cause the one or more flash modules to execute the received database operation command.

### BACKGROUND

This invention relates to a storage apparatus and system configured to store data in an information system.

In recent years, there has been developed a technology for adding a database operation function to an information storage apparatus that uses a semiconductor memory (hereinafter referred to as “solid state drive (SSD)”, or “flash module”), e.g., a flash memory. An SSD including the database operation function has, in addition to a data reading function and a data writing function that have traditionally been included, a function for executing database processing, which hitherto has been executed by a central processing unit (CPU) in a server apparatus.

In Jaeyoung Do, Yang-Suk Kee, Jignesh M. Patel, Chanik Park, Kwanghyun Park, David J. DeWitt, “Query Processing on Smart SSDs: Opportunities and Challenges”, SIGMOD 2013, a user program is executable by a CPU included in an SSD, and a selection query of Microsoft SQL Server (trademark), which is a database product from Microsoft Corporation, is executed by the CPU included in the SSD. In Sungchan Kim, Hyunok Oh, Chanik Park, Sangyeun Cho, Sang-Won Lee, “Fast, Energy Efficient Scan inside Flash Memory SSDs”, ADMS 2011, a calculation module using a system-on-chip technology is arranged in an SSD, and a database operation is executed on data read from a flash memory.

In those technologies, a communication amount between the server apparatus and the SSD is reduced. In general, because an internal data transfer bandwidth of the SSD is larger than the data transfer bandwidth between the server apparatus and the SSD, an improvement in performance is obtained. In Jaeyoung Do, Yang-Suk Kee, Jignesh M. Patel, Chanik Park, Kwanghyun Park, David J. DeWitt, “Query Processing on Smart SSDs: Opportunities and Challenges”, SIGMOD 2013 and Sungchan Kim, Hyunok Oh, Chanik Park, Sangyeun Cho, Sang-Won Lee, “Fast, Energy Efficient Scan inside Flash Memory SSDs”, ADMS 2011, there are disclosed evaluation results showing an improvement in system performance as a result of using an SSD including a database operation function. In Sungchan Kim, Hyunok Oh, Chanik Park, Sangyeun Cho, Sang-Won Lee, “Fast, Energy Efficient Scan inside Flash Memory SSDs”, ADMS 2011, there is disclosed an evaluation result showing, compared with a technology in which a CPU is used, an improvement in energy efficiency as a result of arranging a calculation module using the system-on-chip technology in the SSD.

There also exists a technology for using a flash memory for caching of a storage apparatus. In Jaeyoung Do, Yang-Suk Kee, Jignesh M. Patel, Chanik Park, Kwanghyun Park, David J. DeWitt, “Query Processing on Smart SSDs: Opportunities and Challenges”, SIGMOD 2013, there is disclosed a technology for using a flash memory for caching of a storage apparatus. Caching is a technology for improving access speed by storing frequently accessed data in a high-speed storage medium. Because the access speed of a flash memory is faster than the access speed of a hard disk drive, the access speed of the storage apparatus may be improved by using a flash memory for caching of the storage apparatus.

### SUMMARY

In the above-mentioned related art, an SSD including a database operation function is coupled to one server apparatus, and the database operation function in the SSD cannot be used from a plurality of server apparatus.

It is an object of this invention to enable a database operation function included in a flash module to be used from a plurality of server apparatus.

A representative aspect of the present disclosure is as follows. A storage apparatus to be coupled to a network, the storage apparatus comprising: a controller; and a storage medium to be coupled to the controller, the storage medium comprising one or more flash modules each comprising a database operation module, the controller being configured to receive a database operation command, and to cause the one or more flash modules to execute the received database operation command.

According to this invention, a database operation function included in a flash module can be used by a plurality of server apparatus. Further, processing performance can be improved by running a plurality of flash modules including the database operation function. In addition, a database operation can be executed more quickly on data that is frequently used.

### BRIEF DESCRIPTION OF THE DRAWINGS

FIG. 1 is a block diagram for illustrating an example of a computer system including a storage apparatus according to a first embodiment of this invention.

FIG. 2 is a block diagram for illustrating an example of the storage controller according to the first embodiment of this invention.

FIG. 3 is a diagram for showing the information stored in the address conversion table of the storage controller according to the first embodiment of this invention.

FIG. 4 is a flowchart for illustrating an example of processing performed by the communication module according to the first embodiment of this invention.

FIG. 5 is a flowchart for illustrating an example of processing performed by the IO command control module according to the first embodiment of this invention.

FIG. 6 is a flowchart for illustrating an example of processing performed by the database operation command control module according to the first embodiment of this invention.

FIG. 7 is a table for showing information contained in the database operation command according to the first embodiment of this invention.

FIG. 8 is a table for showing information contained in the database operation drive command according to the first embodiment of this invention.

FIG. 9 is a block diagram for illustrating an example of the flash module controller according to the first embodiment of this invention.

FIG. 10 is a diagram for showing information contained in the drive address conversion table according to the first embodiment of this invention.

FIG. 11 is a flowchart for illustrating an example of processing performed by the database operation drive command control module according to the first embodiment of this invention.

FIG. 12 is a block diagram for illustrating an example of the database operation circuit according to the first embodiment of this invention.

FIG. 13 is a flowchart for illustrating an example of processing performed by the database operation command control module according to a second embodiment of this invention.

FIG. 14 is a diagram for showing information stored in the data transfer database operation command according to the second embodiment of this invention.

FIG. 15 is a block diagram for illustrating an example of the flash module controller according to the second embodiment of this invention.

FIG. 16 is a flowchart for illustrating an example of processing performed by the data transfer database operation command control module according to the second embodiment of this invention.

FIG. 17 is a block diagram for illustrating an example of a computer system including a storage apparatus according to a third embodiment of this invention

FIG. 18 is a table for showing information stored in the memory 114 of the storage controller according to the third embodiment of this invention.

FIG. 19 is a diagram for showing the information stored in the address conversion table according to the third embodiment of this invention.

FIG. 20 is a table for showing data stored in the cache management table according to the third embodiment of this invention.

FIG. 21 is a flowchart for illustrating an example of processing performed by the communication module according to the third embodiment of this invention.

FIG. 22 is a flowchart for illustrating an example of processing performed by the IO command control module according to the third embodiment of this invention.

FIG. 23 is a flowchart for illustrating an example of processing performed by the cache control module according to the third embodiment of this invention.

FIG. 24 is a flowchart for illustrating an example of processing performed by the database operation command control module according to the third embodiment of this invention.

FIG. 25 is a table for showing information contained in each database operation distributed execution command according to the third embodiment of this invention.

FIG. 26 is a block diagram for illustrating an example of the flash module controller according to the third embodiment of this invention.

FIG. 27 is a diagram for showing information contained in the module address conversion table included in the flash module controller according to the third embodiment of this invention.

FIG. 28 is the first half of a flowchart for illustrating an example of processing performed by the database operation distributed execution command control module according to the third embodiment of this invention.

FIG. 29 is the second half of the flowchart for illustrating an example of processing performed by the database operation distributed execution command control module according to the third embodiment of this invention.

### DETAILED DESCRIPTION OF THE PREFERRED EMBODIMENTS

Embodiments of this invention are now described with reference to the attached drawings.

### First Embodiment

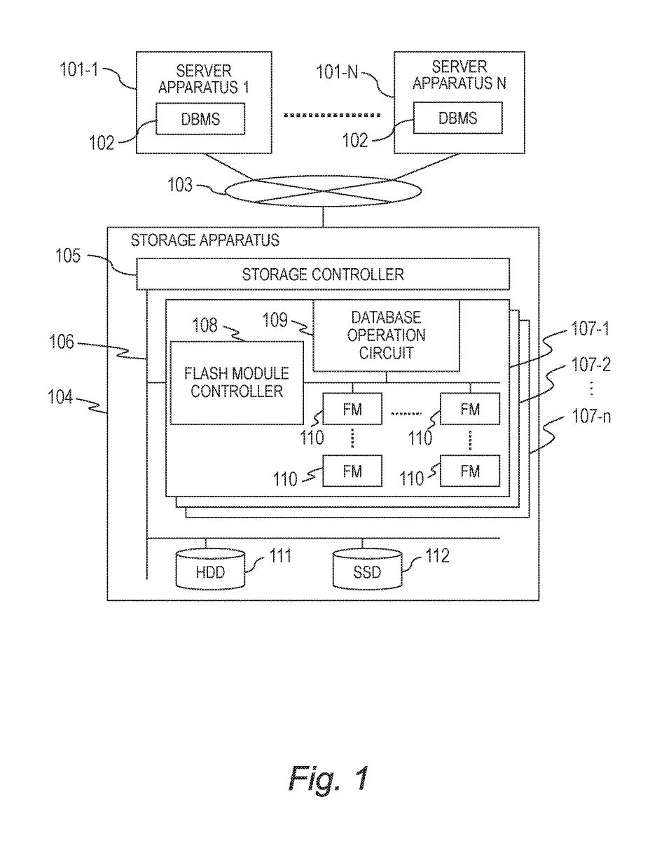

FIG. 1 is a block diagram for illustrating an example of a computer system including a storage apparatus according to this invention. As illustrated in FIG. 1, a database management system 102 (hereinafter referred to as “DMBS”) is running in each server apparatus 101-1 to 101-N. The DBMS 102 is a program executed by a CPU included in each server apparatus 101-1 to 101-N. The server apparatus 101-1 to 101-N are coupled to a network 103. In the following description, the server apparatus 101-1 to 101-N are collectively referred to by the reference numeral 101.

A storage apparatus 104 is coupled to the network 103. The storage apparatus 104 is capable of communication to and from the server apparatus 101 via the network 103.

The storage apparatus 104 includes a storage controller 105 configured to control the storage apparatus 104. The storage apparatus 104 also includes flash modules (flash memory modules) 107-1 to 107-n, which are configured to store data and to execute a database operation. In the following description, the flash modules 107-1 to 107-n are collectively referred to by the reference numeral 107.

Each flash module 107 includes a plurality of flash memories 110 (“FM” in FIG. 1), a flash module controller 108 configured to control access to the flash memories 110, and a database operation circuit 109 configured to execute database processing. The database operation circuit 109 is configured to function as a database operation module.

The storage apparatus 104 includes a hard disk drive (hereinafter referred to as “HDD”) 111 as a storage medium configured to store data, a solid-state drive (hereinafter referred to as “SSD”) configured to store data, and the flash modules 107 including the above-mentioned database operation function. The storage controller 105, the flash modules 107, the HDD 111, and the SSD 112 are coupled to each other by a network 106 in the storage apparatus 104. The network 103 is built from a fiber channel, Ethernet, etc. The server apparatus 101 are configured to transmit small computer system interface (SCSI) commands, for example, to the storage apparatus 104 via the network 103.

In FIG. 1, the flash modules 107, which each include a database operation module and are configured to execute operations and store data, serve as a first storage medium, and the HDD 111 and the SSD 112, which are configured to only store data, serve as a second storage medium.

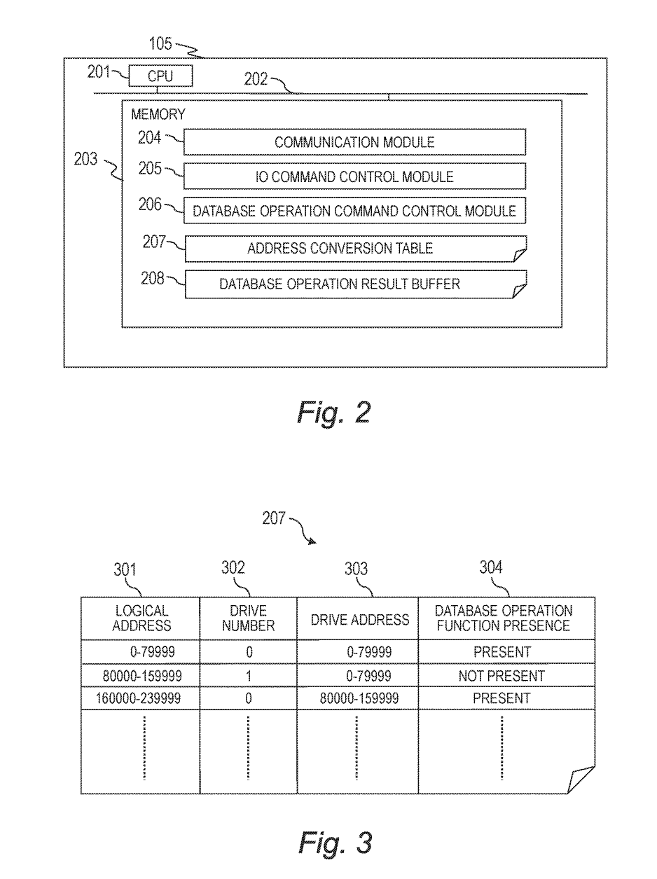

FIG. 2 is a block diagram for illustrating an example of the storage controller 105. The storage controller 105 includes a CPU 201, an internal network 202, and a memory 203.

A communication module 204, an input/output (IO) command control module 205, and a database operation command control module 206 are stored in the memory 203. The communication module 204, the IO command control module 205, and the database operation command control module 206 are programs executed by the CPU 201. An address conversion table 207 and a database operation result buffer 208 are also stored in the memory 203.

Each of the function modules, namely, the communication module 204, the IO command control module 205, and the database operation command control module 206, is loaded in the memory 203 as a program. The CPU 201 is configured to run as a function module for providing a predetermined function by performing processing in accordance with the program of each function module. For example, the CPU 201 is configured to function as the IO command control module 205 by performing processing in accordance with an IO command control program. The same also applies for the other programs. The CPU 201 is also configured to run as a function module for providing each function of the plurality of processes executed by the various programs. A computer and a computer system are an apparatus and a system including those function modules, respectively.

Information on the programs, tables, etc., for implementing each of the functions of the storage controller 105 may be stored in a storage device such as a non-volatile semiconductor memory, a HDD, or an SSD, or in a computer-readable non-transitory data storage medium such as an integrated circuit (IC) card, a secure digital (SD) card, or a digital versatile disc (DVD).

In this embodiment, there is illustrated an example in which the communication module 204, the IO command control module 205, and the database operation command control module 206 are implemented by programs executed by the CPU 201. However, the communication module 204, the IO command control module 205, and the database operation command control module 206 may be implemented as logic circuits.

FIG. 3 is a diagram for showing the information stored in the address conversion table 207 of the storage controller 105. As shown in FIG. 3, a logical address 301, a drive number 302, a drive address 303, and a database operation function presence 304 are stored in each record in the address conversion table 207.

The logical address 301 represents an address to be used when the server apparatus 101 reads and writes data stored in the storage apparatus 104. The drive number 302 represents an identification number assigned by the storage apparatus 104 to the flash modules 107, the HDD 111, and the SSD 112 in the storage apparatus 104.

The drive address 303 represents an address to be used when the storage controller 105 reads and writes data stored in the flash modules 107, the HDD 111, and the SSD 112. The database operation function presence 304 represents information indicating whether or not a relevant drive has the database operation function (database operation circuit 109).

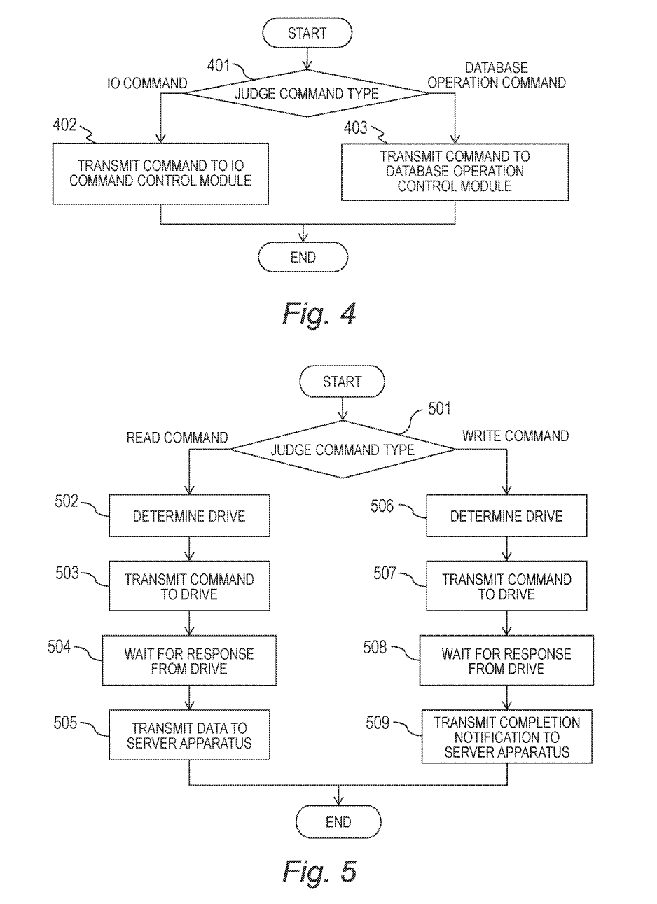

FIG. 4 is a flowchart for illustrating an example of processing performed by the communication module 204. The communication module 204 starts the processing when a command is received from the server apparatus 101.

In Step 401, the communication module 204 judges a type of a received command. The command type is set to be one of an IO command and a database operation command. When the command type is an IO command, in Step 402, the communication module 204 transmits the command to the IO command control module 205.

On the other hand, when the command type is a database operation command, in Step 403, the communication module 204 transmits the command to the database operation command control module 206.

Based on the processing described above, the communication module 204 sorts transfer destinations in accordance with the received command type.

FIG. 5 is a flowchart for illustrating an example of processing performed by the IO command control module 205. The IO command control module 205 starts the processing when a command is received from the communication module 204. In Step 501,

the IO command control module 205 judges the command type. As the command type, one of a READ command and a WRITE command is set.

When the command type is a READ command, in Step 502, the IO command control module 205 determines the drive. The drive determination is performed by using information on the logical address 301 of the data to be read, which is included in the command, and information on the drive number 302 in the address conversion table 207. In other words, the IO command control module 205 determines which drive number 302 has the drive address 303 including the logical address 301 included in the command by referring to the address conversion table 207.

In Step 503, the IO command control module 205 transmits the READ command to the drive having the drive number determined in Step 502. In Step 504, the IO command control module 205 waits for a response from the drive that the command was transmitted to. In Step 505, the IO command control module 205 transmits READ data received from the drive to the server apparatus 101.

On the other hand, when the command type is a WRITE command, in Step 506, the IO command control module 205 determines the drive. The drive determination is performed by using information on the logical address 301 of the data to be written, which is included in the command, and information in the address conversion table 207. In other words, the IO command control module 205 determines which drive number 302 includes the logical address 301 included in the command by referring to the address conversion table 207.

In Step 507, the IO command control module 205 transmits the WRITE command to the drive having the drive number determined in Step 506.

In Step 508, the IO command control module 205 waits for a response from the drive that the command was transmitted to. In Step 509, the IO command control module 205 notifies the server apparatus 101 that the WRITE command is complete.

Based on the processing described above, the IO command control module 205 in the storage controller 105 may access the storage media (flash modules 107, HDD 111, and SSD 112) in accordance with one of a READ command and a WRITE command.

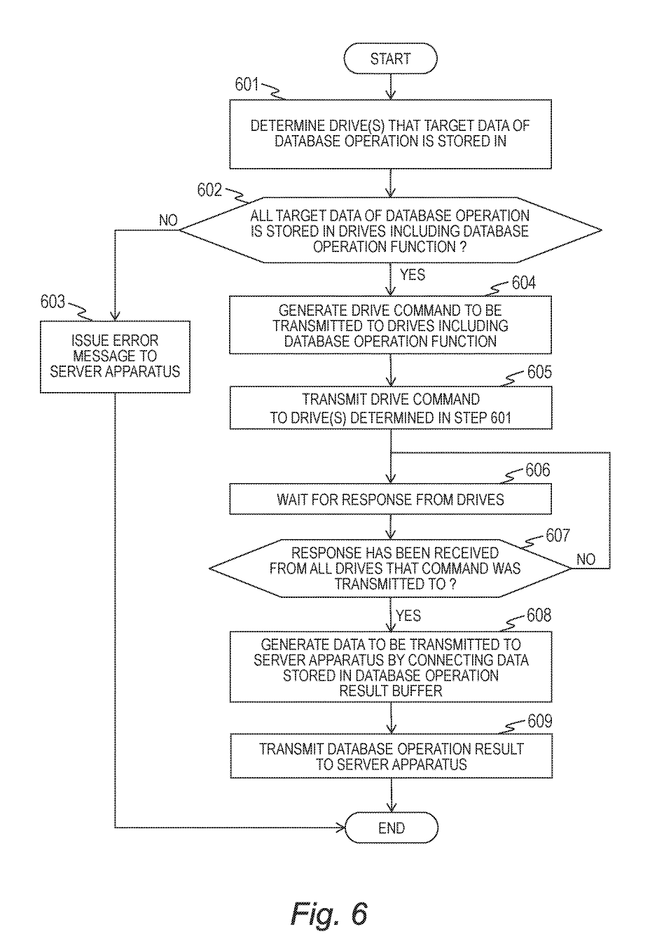

FIG. 6 is a flowchart for illustrating an example of processing performed by the database operation command control module 206. The database operation command control module 206 starts the processing when a database operation command 701 is received from the communication module 204.

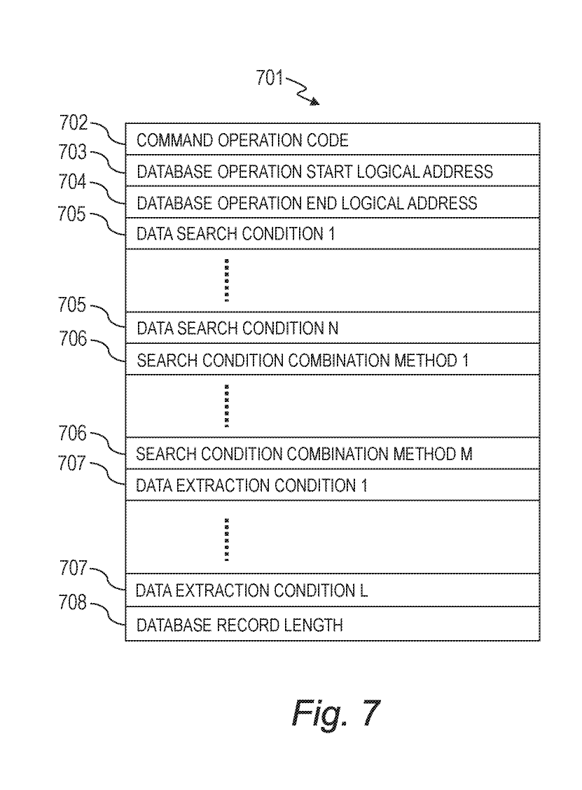

FIG. 7 is a table for showing information contained in the database operation command 701. The database operation command 701 includes a command operation code 702, a database operation start logical address 703, a database operation end logical address 704, a data search condition 705, a search condition combination method 706, a data extraction condition 707, and a database record length 708.

The command operation code 702 represents a code indicating that the command is a database operation command 701. The database operation start logical address 703 represents the logical address 301 that the database operation starts at. The database operation end logical address 704 represents the logical address 301 that the database operation ends at. The data search condition 705 represents a condition for searching for data in the database.

The condition for searching for data in the database includes a storage position of data to be compared, a value of the data to be compared, and a comparison method. For example, the condition may be a condition for comparing data stored from the 0-th byte to the 7-th byte of data in the database with a value “10” of the data to be compared, and judging whether or not the data is larger than the data to be compared.

In the search condition combination method 706, a method of combining the data search condition 705 by AND or OR is defined. For example, the search condition combination method 706 may be a method in which the data search condition 705 is combined by AND or OR, e.g., (data search condition 1) AND (data search condition 2) OR (data search condition 3).

In the data extraction condition 707, a condition is set for extracting data to be transmitted to the server apparatus 101 from among data matching the data search condition 705 and the search condition combination method 706. For example, a condition for extracting from the 0-th byte to the 7-th byte of the database is stored in the data extraction condition 707. The database record length 708 represents the length of one record in the database.

In Step 601 of FIG. 6, the database operation command control module 206 determines the drive(s) that the target data of the database operation is stored in. In the drive determination performed in Step 601, the drive number 302 is determined by using the address conversion table 207, the logical address 301 of the database operation start logical address 703, and the logical address 301 of the database operation end logical address 704. A plurality of drives may be determined in Step 601.

In Step 602, the database operation command control module 206 judges whether or not all the target data of the database operation is stored in drives including the database operation function. This judgment is performed by referring to the database operation function presence 304 in the address conversion table 207, and judging whether or not all the drives determined in Step 601 have the database operation function.

When it is judged in Step 602 that not all the target data of the database operation is stored in drives including the database operation function, in Step 603, the database operation command control module 206 issues an error message to the server apparatus 101. The error message issued to the server apparatus 101 includes, for example, the logical address of the data stored in a drive that is specified in the database operation command as being the target of the database operation and that does not include the database operation function.

When it is judged in Step 602 that all the target data of the database operation is stored in drives including the database operation function, in Step 604, the database operation command control module 206 generates a database operation drive command 801 to be transmitted to the drives (flash modules 107) including the database operation function.

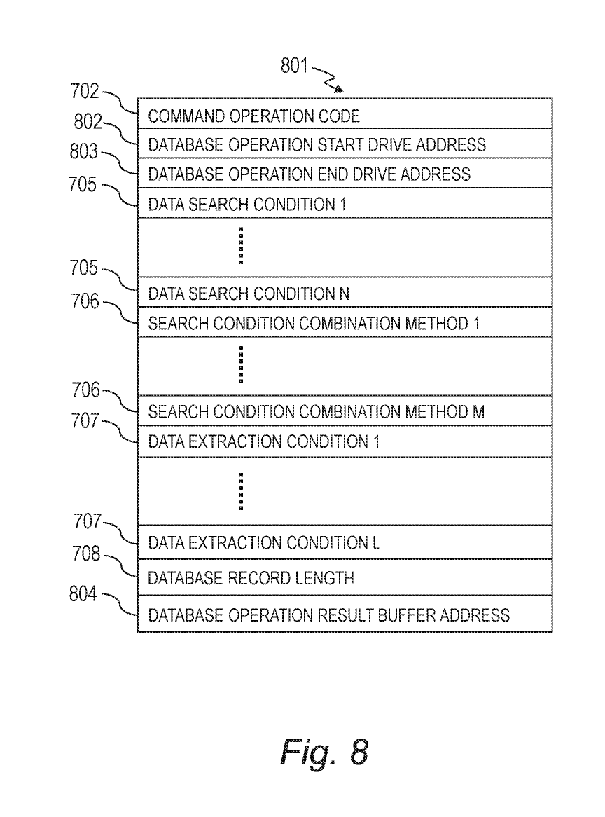

FIG. 8 is a table for showing information contained in the database operation drive command 801. The database operation drive command 801 includes, in addition to the same information as the database operation command 701 shown in FIG. 7, a database operation start drive address 802, a database operation end drive address 803, and a database operation result buffer address 804.

The database operation start drive address 802 represents the drive address 303 that the database operation to be executed by a relevant drive is to start at. The database operation end drive address 803 represents the drive address 303 that the database operation to be executed by the relevant drive is to end at.

The database operation start drive address 802 and the database operation end drive address 803 are determined by the database operation command control module 206 referring to the address conversion table 207. The database operation result buffer address 804 represents the address of the database operation result buffer 208 storing a database operation result.

In Step 605 of FIG. 6, the database operation command control module 206 transmits the database operation drive command 801 to the drive(s) (flash module(s) 107) determined in Step 601.

In Step 606, the database operation command control module 206 waits for a response from the drives. When a response is received from a drive, in Step 607, the database operation command control module 206 judges whether or not a response has been received from all the drives that the database operation drive command 801 was transmitted to.

When it is judged in Step 607 that a response has not been received from all the drives, the database operation command control module 206 returns the processing to Step 606. When it is judged in Step 607 that a response has been received from all the drives, in Step 608, the database operation command control module 206 generates data to be transmitted to the server apparatus 101 by using operation result data stored in the database operation result buffer 208.

The processing of Step 608 is referred to as database operation result generation processing. As the database operation result generation processing, there are processing for connecting the operation result data stored in the database operation result buffer 208, processing for assigning header information and trailer information to be transmitted to the server apparatus 101, and processing for assigning an identifier to be associated with a database operation command received from the server apparatus 101.

In Step 609, the database operation command control module 206 transmits the database operation result generated by the database operation result generation processing to the server apparatus 101.

Based on the processing described above, the database operation command control module 206 generates the database operation drive command 801 based on the received database operation command 701, and transmits the generated database operation drive command 801 to at least one drive (flash module 107) including the database operation function.

Then, when the database operation command control module 206 has received the operation result from all the drives that the database operation drive command 801 was transmitted to, the database operation command control module 206 generates the database operation result by database operation result generation processing, and transmits the generated database operation result to the server apparatus 101.

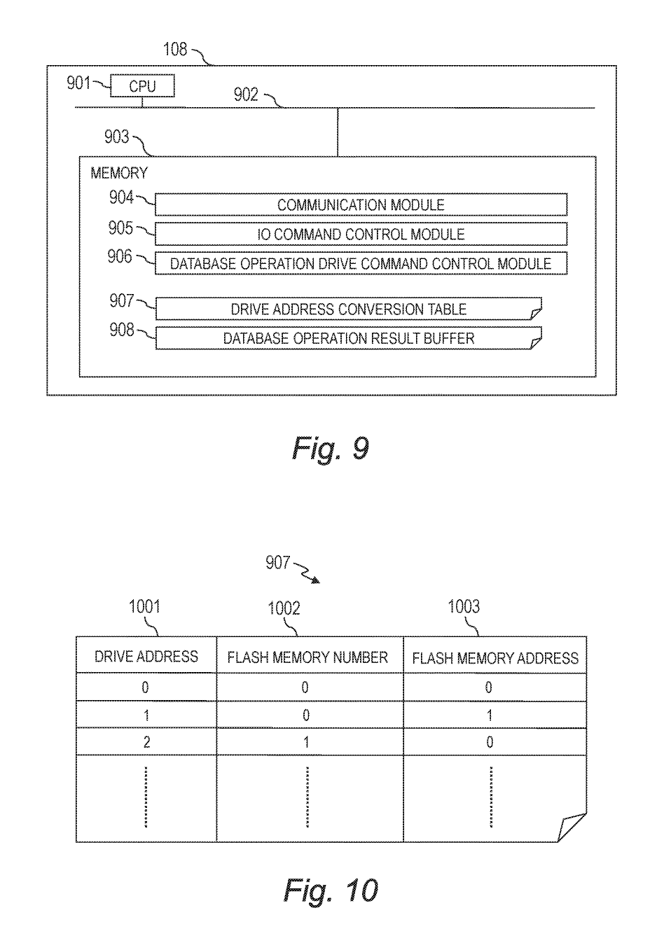

FIG. 9 is a block diagram for illustrating an example of the flash module controller 108. As illustrated in FIG. 9, the flash module controller 108 includes a CPU 901, an internal network 902, and a memory 903.

The CPU 901 and the memory 903 are coupled to each other by the internal network 902. A communication module 904, an IO command control module 905, and a database operation drive command control module 906 are stored in the memory 903. The communication module 904, the IO command control module 905, and the database operation drive command control module 906 are programs executed by the CPU 901. A drive address conversion table 907 and a database operation result buffer 908 are also stored in the memory 903.

Similar to the above-mentioned storage controller 105, in the flash module controller 108 as well, each of the function modules, namely, the communication module 904, the IO command control module 905, and the database operation drive command control module 906, is loaded in the memory 203 as a program. The CPU 901 is configured to run as a function module for providing a predetermined function by performing processing in accordance with the program of each function module.

FIG. 10 is a diagram for showing information contained in the drive address conversion table 907 stored by the flash module controller 108 in the memory 903.

As shown in FIG. 10, a drive address 1001, a flash memory number 1002, and a flash memory address 1003 are stored in each record in the drive address conversion table 907.

The drive address 1001 represents the address to be used when the storage controller 105 reads and writes data stored in the flash modules 107. The flash memory number 1002 represents the number for identifying the flash memories 110 of the flash modules 107. The flash memory address 1003 represents the address to be used when reading and writing the data stored in the flash memories 110.

The communication module 904 in the flash module controller 108 is configured to transmit, when a command is received from the storage controller 105, the received command to the IO command control module 905 when the command is an IO command. The communication module 904 in the flash module controller 108 is configured to transmit, when a command is received from the storage controller 105, the received command to the database operation drive command control module 906 when the command is a database operation drive command.

When an IO command is received from the communication module 904, the IO command control module 905 reads data from the flash memories 110 when the IO command is a READ command, and transmits the read data to the storage controller 105.

When an IO command is received from the communication module 904, the IO command control module 905 writes data to the flash memories 110 when the IO command is a WRITE command, and transmits a data write completion notification to the storage controller 105.

When the IO command control module 905 is processing the command, the IO command control module 905 refers to the drive address conversion table 907 to convert the drive address 1001 into the flash memory number 1002 and the flash memory address 1003, and reads and writes the data of the flash memories 110.

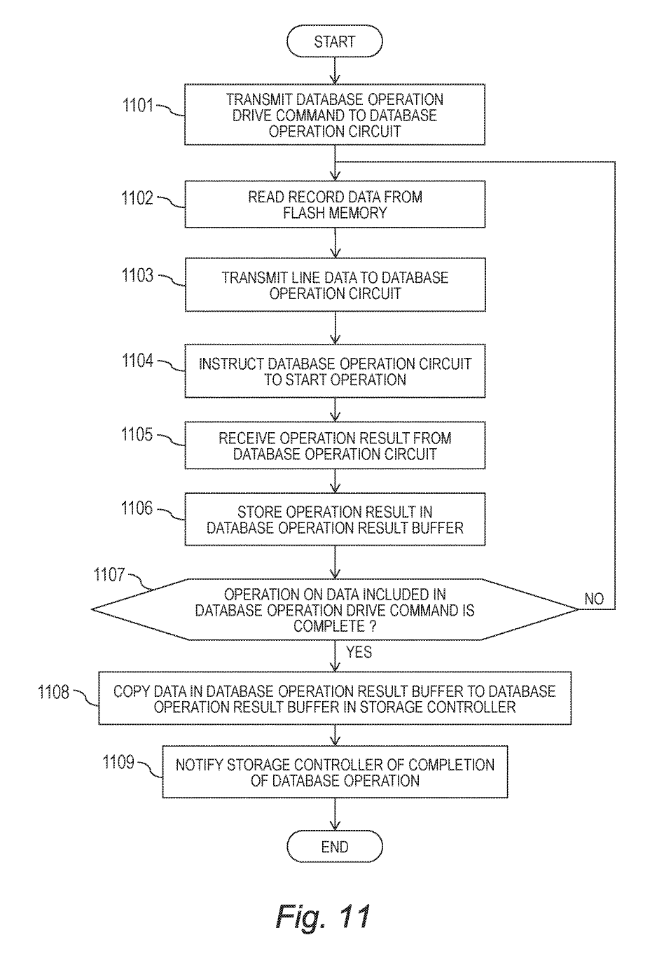

FIG. 11 is a flowchart for illustrating an example of processing performed by the database operation drive command control module 906. The database operation drive command control module 906 starts the processing when the database operation drive command 801 is received from the communication module 904. In Step 1101, the database operation drive command control module 906 transmits the database operation drive command 801 to the database operation circuit 109.

In Step 1102, the database operation drive command control module 906 reads record data of the database from the flash memories 110. In Step 1102, the database operation drive command control module 906 uses the database record length 708 and the database operation start drive address 802 stored in the database operation drive command 801. More specifically, in Step 1102, the database operation drive command control module 906 reads from the flash memories 110 the number of bytes stored in the database record length 708 from the database operation start drive address 802 shown in FIG. 8.

In Step 1103, the database operation drive command control module 906 transmits the record data read in Step 1102 to the database operation circuit 109. In Step 1104, the database operation drive command control module 906 instructs the database operation circuit 109 to start the operation.

In Step 1105, the database operation drive command control module 906 receives an operation result from the database operation circuit 109. In Step 1106, the database operation drive command control module 906 stores the operation result received in Step 1105 in the database operation result buffer address 804. In Step 1107, the database operation drive command control module 906 judges whether or not the operation on the data stored in the database operation drive command 801 is totally complete. The judgment regarding whether or not the operation on the data stored in the database operation drive command 801 is complete is performed based on whether or not the database operation has been completed until the database operation end drive address 803 included in the database operation drive command 801.

When it is judged in Step 1107 that the operation on the data stored in the database operation drive command 801 is not totally complete, the processing returns to Step 1102. Then, in Step 1102, the database operation drive command control module 906 reads record data from the next address of the address read from the flash memories 110 the previous time.

On the other hand, when it is judged in Step 1107 that the operation on the data stored in the database operation drive command 801 is totally complete, in Step 1108, the database operation drive command control module 906 copies the data in the database operation result buffer 908 to the database operation result buffer 208 in the storage controller 105.

When the database operation drive command control module 906 copies from the database operation result buffer 908 to the database operation result buffer 208, the database operation result buffer address 804 included in the database operation drive command 801 is used. More specifically, the data in the database operation result buffer 908 is copied to the database operation result buffer address 804 of the database operation result buffer 208.

Based on the processing described above, the database operation drive command control module 906 causes the database operation circuit 109 to process the data read from the flash memories 110 of the flash modules 107. Then, the database operation drive command control module 906 collectively stores the processing results received from the database operation circuit 109 in the database operation result buffer 208 of the storage controller 105.

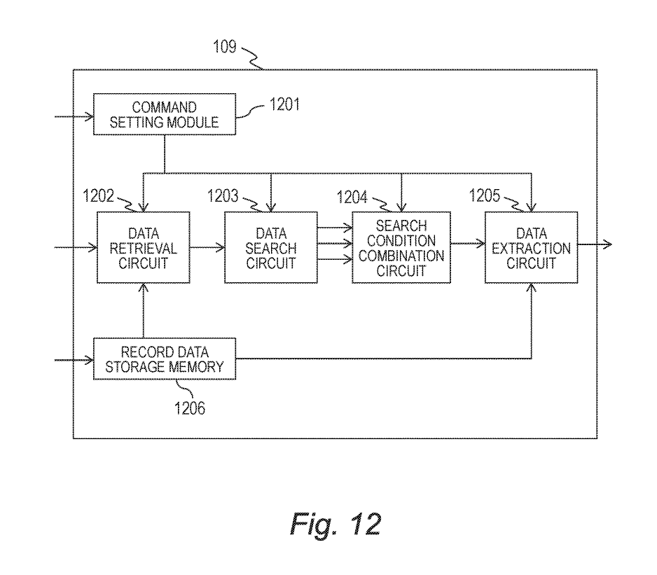

FIG. 12 is a block diagram for illustrating an example of the database operation circuit 109. As illustrated in FIG. 12, the database operation circuit 109 includes a command setting module 1201, a data retrieval circuit 1202, a data search circuit 1203, a search condition combination circuit 1204, a data extraction circuit 1205, and a record data storage memory 1206.

The command setting module 1201 is configured to start processing when the database operation drive command 801 is received from the database operation drive command control module 906. The command setting module 1201 is configured to extract from the received database operation drive command 801 the information necessary for the data retrieval circuit 1202, the data search circuit 1203, the search condition combination circuit 1204, and the data extraction circuit 1205, and to set the extracted information in each circuit.

The command setting module 1201 is configured to set in the data retrieval circuit 1202 a byte position of the record data to be compared that is stored in the data search condition 705 from the database operation drive command 801.

The command setting module 1201 is configured to extract from the database operation drive command 801 the comparison method of the record data stored in the data search condition 705, and to set the extracted comparison method in the data search circuit 1203. An example of the comparison method of the record data is a pair of a magnitude comparison condition and comparison value.

The command setting module 1201 is configured to set the search condition combination method 706 from the database operation drive command 801 in the search condition combination circuit 1204. The combination method is a method of combining search conditions by AND or OR, such as by combining (first condition) AND (second condition) OR (third condition).

The command setting module 1201 is configured to set the data extraction condition 707 from the database operation drive command 801 in the data extraction circuit 1205. The data extraction condition 707 includes, for example, a condition for retrieving data from the record data, such as retrieving the 7-th byte from the 0-th byte of the record data, or the 23-rd byte from the 15-th byte of the record data.

The record data storage memory 1206 is configured to store the record data received from the database operation drive command control module 906. The record data storage memory 1206 is referred to as necessary by the data retrieval circuit 1202 and the data extraction circuit 1205.

The data retrieval circuit 1202 is configured to start the processing when an operation start instruction is received from the database operation drive command control module 906. The data retrieval circuit 1202 is configured to retrieve data from the record data storage memory 1206 based on the byte position of the record data to be compared, which is stored in the data search condition 705 of the database operation drive command 801, and to transmit the retrieved data to the data search circuit 1203.

The data search circuit 1203 is configured to judge whether or not the data received from the data retrieval circuit 1202 matches the condition based on the comparison method of the record data, and to transmit the judgment result of whether or not the condition is matched to the search condition combination circuit 1204.

The search condition combination circuit 1204 is configured to combine the judgment result received from the data search circuit 1203 based on the search condition combination method 706, and to transmit the judgment result to the data extraction circuit 1205. The data extraction circuit 1205 is configured to not perform processing when the judgment result received from the search condition combination circuit 1204 is false (i.e., there is no match). The data extraction circuit 1205 is configured to extract, when the judgment result received from the search condition combination circuit 1204 is true (i.e., there is a match), the data from the record data storage memory 1206 in accordance with the data extraction condition 707, and to transmit the extracted data to the database operation drive command control module 906. In this embodiment, there is illustrated an example in which the database operation circuit 109 is implemented by hardware. However, the database operation circuit 109 may also be implemented by a program executed by the CPU 901. In that case, the CPU 901 is configured to function as the database operation module by executing a database operation program loaded in the memory 903.

Thus, according to the first embodiment of this invention, because a plurality of the flash modules 107, which each include the database operation function, are included in the storage apparatus 104, a plurality of server apparatus 101 may use the database operation function included in each flash module 107.

### Second Embodiment

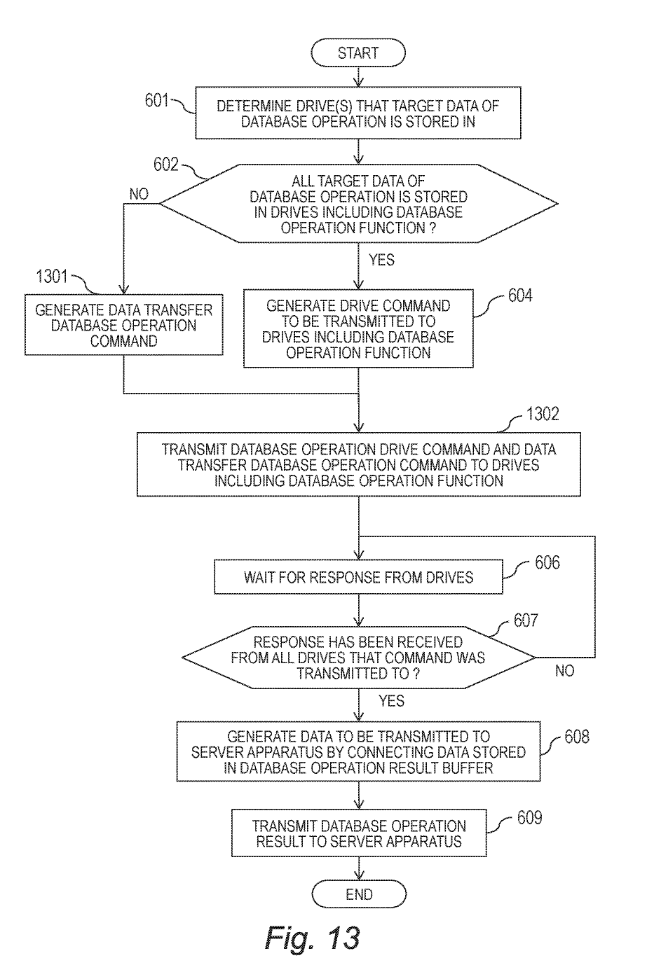

FIG. 13 to FIG. 16 are diagrams for illustrating a second embodiment of this invention. FIG. 13 is a flowchart for illustrating an example of processing performed by the database operation command control module 206 in the second embodiment. In FIG. 13, Step 603 of the flowchart illustrated in FIG. 6 of the first embodiment is replaced by Step 1301, and Step 1302 is added. Step 1302 is executed after the processing of Step 1301. The other processing is the same as in the first embodiment.

In Step 601 of FIG. 13, the database operation command control module 206 determines the drive(s) that the target data of the database operation is stored in. Then, in Step 602, the database operation command control module 206 judges whether or not all the target data of the database operation is stored in drives including the database operation function.

When it is judged in Step 602 that not all the target data of the database operation is stored in drives including the database operation function, the database operation command control module 206 advances the processing to Step 1301.

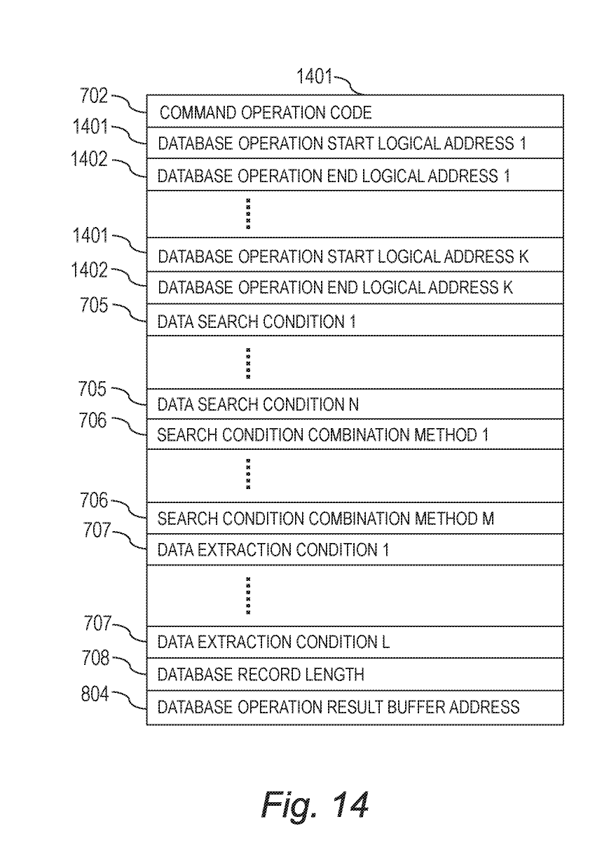

In Step 1301, the database operation command control module 206 generates a data transfer database operation command 1400. FIG. 14 is a diagram for showing information stored in the data transfer database operation command 1400.

In FIG. 14, a database operation start logical address 1401, a database operation end logical address 1402, and information (702 to 804) on the database operation drive command 801 are stored in the data transfer database operation command 1400. More specifically, in the data transfer database operation command 1400 shown in FIG. 14, the database operation start drive address 802 and the database operation end drive address 803 shown in the database operation drive command 801 of FIG. 8 are replaced by the database operation start logical address 1401 and the database operation end logical address 1402.

Of the logical addresses of the target data of the database operation specified in the data transfer database operation command 1400, the logical addresses of the data stored in the HDD 111 and the SSD 112, which are drives that do not have the database operation function, are included in the database operation start logical address 1401 and the database operation end logical address 1402.

In Step 1302 of FIG. 13, the database operation command control module 206 transmits the data transfer database operation command 1400 including the database operation drive command 801 to the drives (flash modules 107) including the database operation function.

More specifically, when the database processing target is not stored in the flash modules 107, but is stored in another drive (second storage medium), the database operation command control module 206 is capable of acquiring the data from one of the HDD 111 and the SSD 112 via the storage controller 105, which is a higher-level apparatus, and executing the operation on the acquired data by the database operation circuit 109 of the flash modules 107.

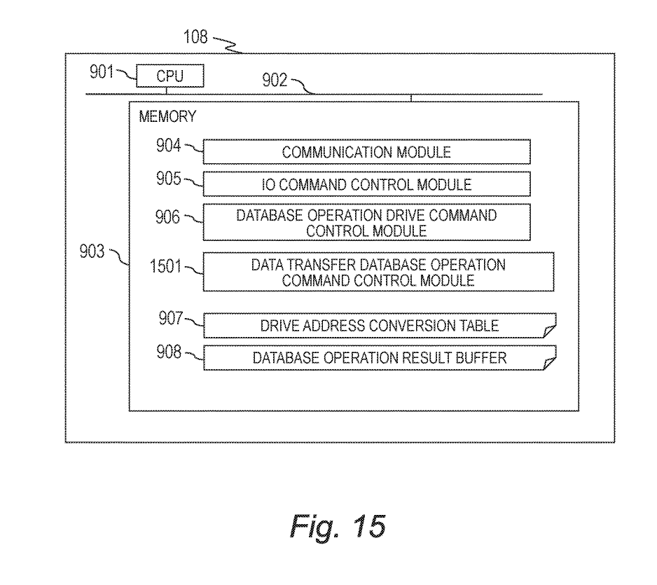

FIG. 15 is a block diagram for illustrating an example of the flash module controller 108 according to the second embodiment. The flash module controller 108 includes, in addition to the structures illustrated in FIG. 9 described in the first embodiment, a data transfer database operation command control module 1501.

The communication module 904 is configured to transmit, when the data transfer database operation command 1400 is received, that data transfer database operation command 1400 to the data transfer database operation command control module 1501.

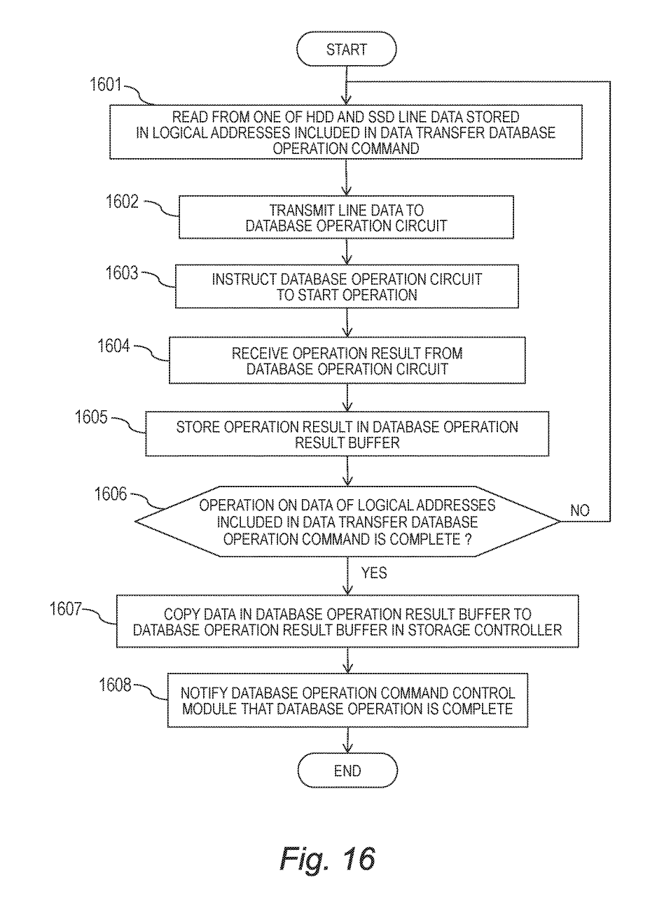

FIG. 16 is a flowchart for illustrating an example of processing performed by the data transfer database operation command control module 1501.

In Step 1601, the data transfer database operation command control module 1501 reads from one of the HDD 111 and the SSD 112 the record data stored in the logical addresses (1401, 1402) included in the data transfer database operation command 1400.

In Step 1601, the data transfer database operation command control module 1501 transmits a READ command including the logical address and the database record length 708 of the data to be read to the IO command control module 205 in the storage controller 105.

In Step 1602, the data transfer database operation command control module 1501 transmits the record data read from the one of the HDD 111 and the SSD 112 to the database operation circuit 109.

In Step 1603, the data transfer database operation command control module 1501 instructs the database operation circuit 109 to start the operation. In Step 1604, the data transfer database operation command control module 1501 receives an operation result from the database operation circuit 109. In this step, the data transfer database operation command control module 1501 waits until a response is received for the operation the database operation circuit 109 has been instructed to perform.

In Step 1605, the data transfer database operation command control module 1501 stores the received operation result in the database operation result buffer 908. In Step 1606, the data transfer database operation command control module 1501 judges whether or not the operation on the data of the logical addresses included in the data transfer database operation command 1400 is complete.

When it is judged that the operation is not complete, the data transfer database operation command control module 1501 returns the processing to Step 1601, and repeats the processing described above.

When it is judged that the operation is complete, in Step 1607, the data transfer database operation command control module 1501 copies the data in the database operation result buffer 908 to the database operation result buffer 208 in the storage controller 105.

In Step 1608, the data transfer database operation command control module 1501 notifies the database operation command control module 206 that the database operation is complete.

Thus, in the second embodiment of this invention, through using the data transfer database operation command 1400, there is obtained an advantageous effect in that a database operation can be executed even on data that is not stored in the flash modules 107 including the database operation function.

### Third Embodiment

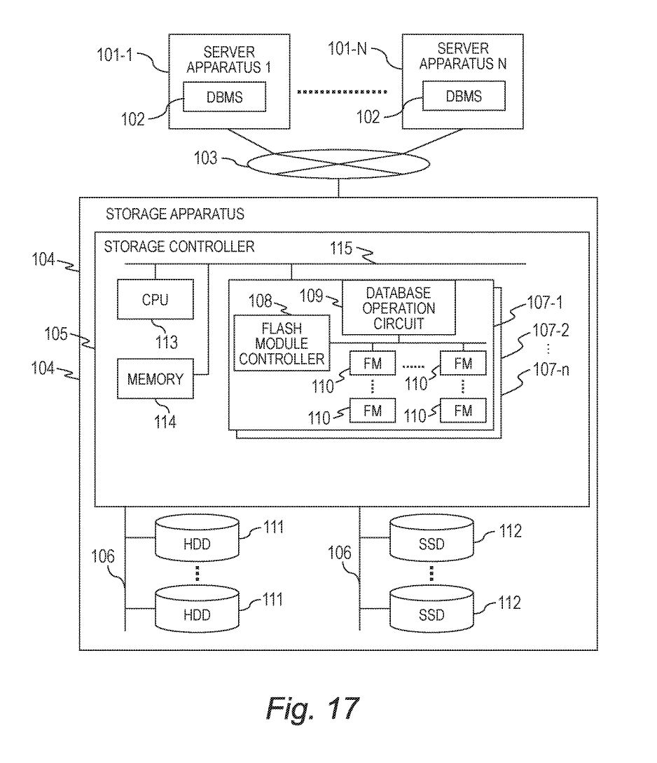

FIG. 17 to FIG. 29 are diagrams for illustrating a third embodiment of this invention. FIG. 17 is a block diagram for illustrating an example of a computer system including a storage apparatus according to the third embodiment. As illustrated in FIG. 17, a DBMS 102 is running in each server apparatus 101. The DBMS 102 is a program executed by a CPU included in each server apparatus 101. The server apparatus 101 are coupled to the network 103.

A storage apparatus 104 is coupled to the network 103. The storage apparatus 104 is capable of communication to and from the server apparatus 101 via the network 103. The storage apparatus 104 includes a storage controller 105 configured to control the storage apparatus 104.

The storage controller 105 includes a CPU 113, a memory 114, and flash modules 107-1 to 107-n configured to store cache data.

Each flash module 107 includes the flash module controller 108, the database operation circuit 109, and the flash memories 110. The CPU 113, the memory 114, and the flash modules 107 are coupled to each other by an internal network 115.

The storage apparatus 104 includes the HDD 111 and the SSD 112 as a storage medium configured to store data. The storage apparatus 104 includes in the storage controller 105 the flash modules 107 as a cache for storing frequently used data. The storage controller 105, the HDD 111, and the SSD 112 are coupled to each other by a network 106 in the storage apparatus 104.

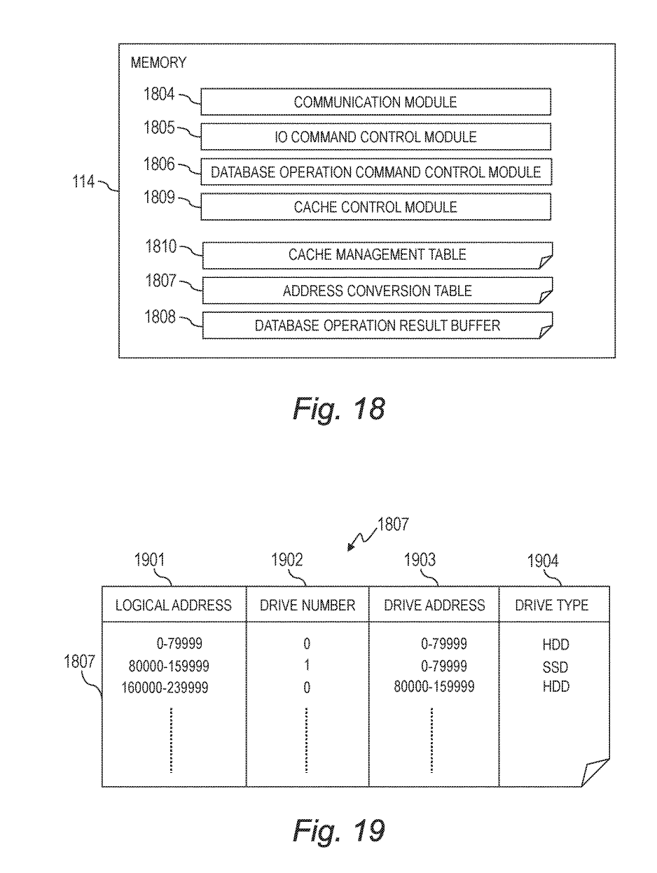

FIG. 18 is a table for showing information stored in the memory 114 of the storage controller 105. A communication module 1804, an IO command control module 1805, a database operation command control module 1806, and a cache control module 1809 are stored in the memory 114.

The communication module 1804, the IO command control module 1805, the database operation command control module 1806, and the cache control module 1809 are programs executed by the CPU 113.

An address conversion table 1807, a database operation result buffer 1808, and a cache management table 1810 are stored in the memory 114. In this embodiment, there is illustrated an example in which the communication module 1804, the IO command control module 1805, and the database operation command control module 1806 are implemented by programs executed by the CPU 113. However, the communication module 1804, the IO command control module 1805, the database operation command control module 1806, and the cache control module 1809 may be implemented as logic circuits.

FIG. 19 is a diagram for showing the information stored in the address conversion table 1807. As shown in FIG. 19, a logical address 1901, a drive number 1902, a drive address 1903, and a drive type 1904 are stored in each record in the address conversion table 1807.

The logical address 1901 represents an address to be used when the server apparatus 101 reads and writes data stored in the storage apparatus 104. The drive number 1902 represents an identification number assigned by the storage apparatus 104 to the HDD 111 and the SSD 112 in the storage apparatus 104. The drive address 1903 represents an address to be used when the storage controller 105 reads and writes data stored in the HDD 111 and the SSD 112. The drive type 1904 represents the type of that drive, namely, HDD or SSD.

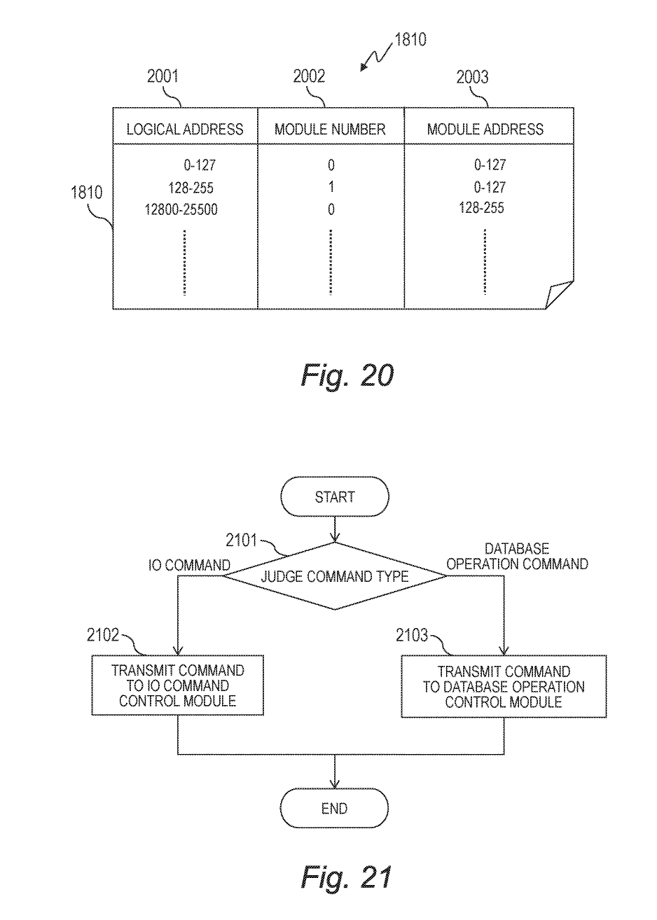

FIG. 20 is a table for showing data stored in the cache management table 1810. A logical address 2001, a module number 2002, and a module number address 2003 are stored in each record in the cache management table 1810.

The logical address 2001 represents the logical address 1901 of the data cached in the flash modules 107. The module number 2002 represents a number for identifying each of the flash modules 107-1 to 107-n. The module address 2003 represents the address to be used by the IO command control module 1805 when accessing the data stored in the flash modules 107.

FIG. 21 is a flowchart for illustrating an example of processing performed by the communication module 1804. The communication module 1804 starts the processing when a command is received from the server apparatus 101. In Step 2101, the communication module 1804 judges the command type. The command type is set to be one of an IO command and a database operation command.

When the command type is an IO command, in Step 2102, the communication module 1804 transmits the IO command to the IO command control module 1805. On the other hand, when the command type is a database operation command, in Step 2103, the communication module 1804 transmits the command to the database operation command control module 1806.

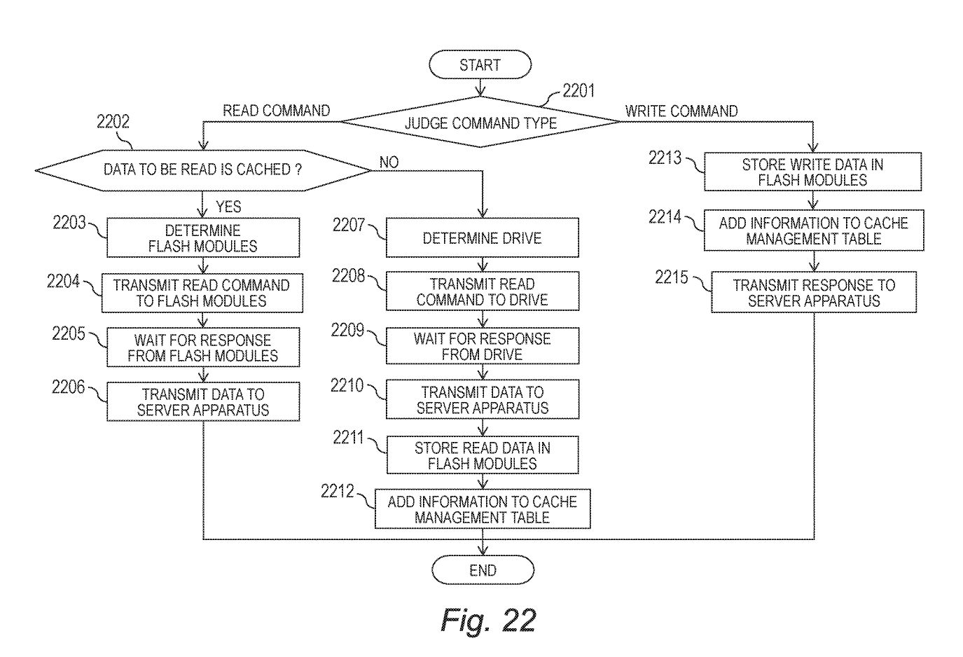

FIG. 22 is a flowchart for illustrating an example of processing performed by the IO command control module 1805. The IO command control module 1805 starts the processing when a command is received from the communication module 1804. In Step 2201, the IO command control module 1805 judges the command type. As the command type, one of a READ command and a WRITE command is set.

When the command type is a READ command, in Step 2202, the IO command control module 1805 judges whether or not the data to be read is cached in the flash modules 107.

The judgment in Step 2202 is performed by comparing the logical address 1901 stored in the cache management table 1810 with the logical address of the data to be read included in the command.

When it is judged in Step 2202 that the data to be read is cached in the flash modules 107, in Step 2203, the IO command control module 1805 determines the flash modules 107 that the data is cached in. The determination is performed by the IO command control module 1805 referring to the cache management table 1810, and identifying the module number 2002 corresponding to the logical address 2001.

In Step 2204, the IO command control module 1805 transmits the READ command to the flash modules 107 determined in Step 2203. For transmission of the READ command to the flash modules 107, the module address 2003 stored in the cache management table 1810 is used.

In Step 2205, the IO command control module 1805 waits for a response from the flash modules 107 that the READ command was transmitted to. When a response is received from a flash module 107, in Step 2206, the IO command control module 1805 transmits the READ data received from the flash module 107 to the server apparatus 101.

On the other hand, when it is judged in Step 2202 that the data to be read is not cached in the flash modules 107, in Step 2207, the IO command control module 1805 refers to the address conversion table 1807, and identifies the drive number 1902 corresponding to the logical address 1901. As a result, the drive that the data is stored in is determined.

In Step 2208, the IO command control module 1805 transmits the READ command to the drive determined in Step 2207. For transmission of the READ command to the drive, the drive address 1903 stored in the address conversion table 1807 is used.

In Step 2209, the IO command control module 1805 waits for a response from the drive to which the READ command was transmitted. When a response from the drive is received, in Step 2210, the IO command control module 1805 transmits the READ data to the server apparatus 101.

In Step 2211, the IO command control module 1805 stores the data read from the drive in the flash modules 107. In Step 2212, the IO command control module 1805 adds information on the data stored in the flash modules 107 to the cache management table 1810.

When it is judged in Step 2201 that the command type is a WRITE command, in Step 2213, the IO command control module 1805 stores the WRITE data received from the server apparatus 101 in the flash modules 107.

In Step 2214, the IO command control module 1805 adds information on the data stored in the flash modules 107 to the cache management table 1810. In Step 2215, the IO command control module 1805 transmits to the server apparatus 101 a response indicating that the WRITE command is complete.

Based on the processing described above, non-cached data is written to the flash modules 107, and then one of a READ response and a WRITE response is transmitted to the server apparatus 101.

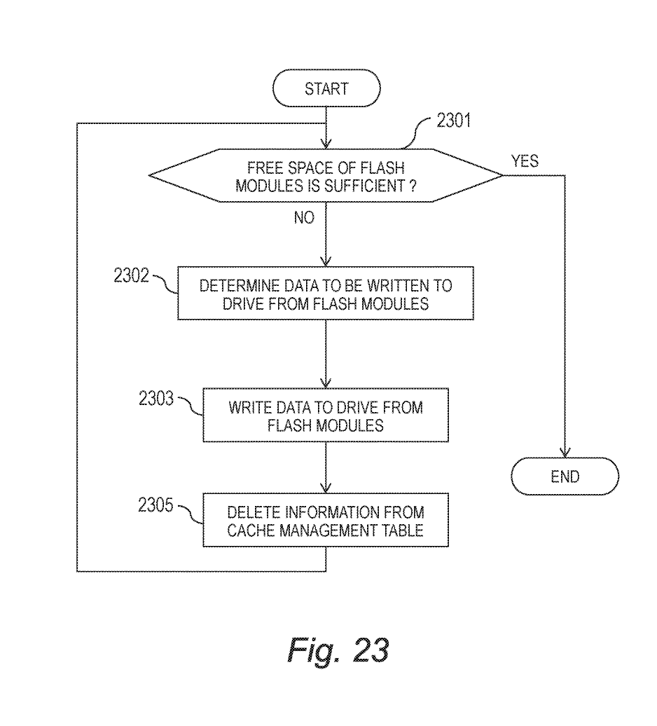

FIG. 23 is a flowchart for illustrating an example of processing performed by the cache control module 1809. The cache control module 1809 starts the processing at fixed intervals determined in advance.

In Step 2301, the cache control module 1809 judges whether or not the free space of the flash modules 107 is sufficient. Step 2301 is executed by the cache control module 1809 based on the information in the cache management table 1810 and a flash module usage threshold determined in advance. For example, when the flash module usage threshold is determined to be 50%, in Step 2301, the cache control module 1809 judges that the free space of the flash modules 107 is sufficient when the used capacity of the flash modules 107 is 50% or less. When it is judged that the free space of the flash modules 107 is sufficient, the cache control module 1809 ends the processing.

When it is judged that the free space of the flash modules 107 is not sufficient, in Step 2302, the cache control module 1809 determines the data to be written to the drive from the flash modules 107. The determination in Step 2302 is performed by using a common or known algorithm, such as a least recently used (LRU) algorithm.

In Step 2303, the cache control module 1809 writes the data determined in the manner described above to one of the HDD 111 and the SSD 112 from the flash modules 107. In Step 2305, the cache control module 1809 deletes the information on the data written in Step 2303 from the cache management table 1810.

Based on the processing described above, when the free space of the flash modules 107 decreases to the threshold or less, the cache control module 1809 writes data selected by using a LRU algorithm, for example, to the HDD 111 or the SSD 112 to secure free space in the cache.

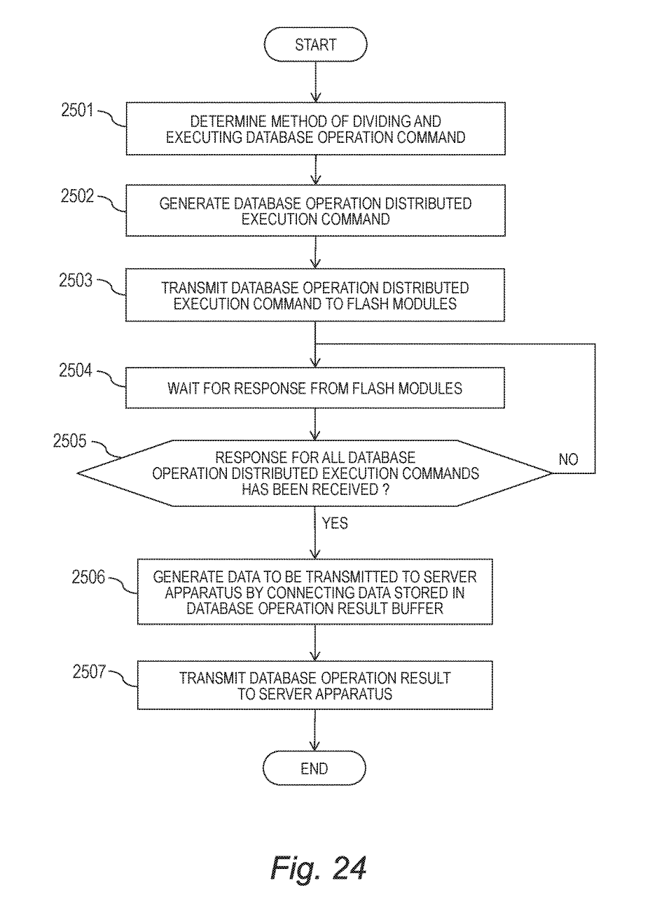

FIG. 24 is a flowchart for illustrating an example of processing performed by the database operation command control module 1806. The database operation command control module 1806 starts the processing when a database operation command 701 is received from the communication module 1804. The database operation command 701 is the same as the database operation command 701 shown in FIG. 7 of the first embodiment.

In Step 2501, the database operation command control module 1806 divides the processing to be performed based on the database operation command 701, and determines processing to be executed by a plurality of the flash modules 107. For example, when the storage apparatus 104 includes three flash modules 107, in Step 2501, the database operation command control module 1806 divides the database operation command 701 into three database operation distributed execution commands 2601, and determines the processing to be performed in parallel by three flash modules 107.

In Step 2501, the database operation command control module 1806 determines that an area from the database operation start logical address 703 to the database operation end logical address 704, which are included in the database operation command 701, is to be equally divided by the number of flash modules 107, and executed by a corresponding number of flash modules 107.

In Step 2502, the database operation command control module 1806 generates the database operation distributed execution command(s) 2601 to be executed in parallel in accordance with the number of flash modules 107.

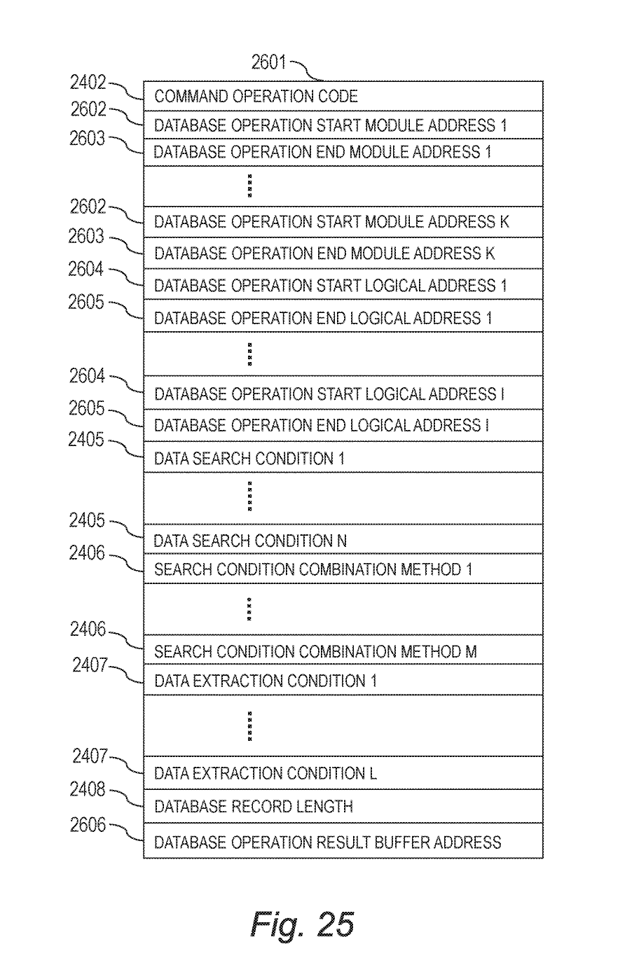

FIG. 25 is a table for showing information contained in each database operation distributed execution command 2601. Each database operation distributed execution command 2601 includes information on a database operation start module address 2602, a database operation end module address 2603, a database operation start logical address 2604, a database operation end logical address 2605, and the database operation command 701.

The database operation start module address 2602 represents, of a database operation execution target area allocated to the flash module 107, the start module address of the data stored in the flash module 107.

The database operation end module address 2603 represents, of a database operation execution target area allocated to the flash module 107, the end module address of the data stored in the flash module 107.

The database operation start logical address 2604 represents, of a database operation execution target area allocated to the flash module 107, the start logical address of the data not stored in the flash module 107.

The database operation end logical address 2605 represents, of a database operation execution target area allocated to the flash module 107, the end logical address of the data not stored in the flash module.

In Step 2503 of FIG. 24, the database operation command control module 1806 transmits the database operation distributed execution command 2601 to each of the flash modules 107 determined in Step 2501.

In Step 2504, the database operation command control module 1806 waits for a response from each of the flash modules 107 that the database operation distributed execution command 2601 was transmitted to.

In Step 2505, the database operation command control module 1806 judges whether or not a response has been received from all the flash modules 107 that the database operation distributed execution command 2601 was transmitted to.

When it is judged in Step 2505 that a response has not been received from all the flash modules 107 that the database operation distributed execution command 2601 was transmitted to, the database operation command control module 1806 returns the processing to Step 2504, and waits for a response.

On the other hand, when it is judged in Step 2505 that a response has been received from all the flash modules 107 that the database operation distributed execution command 2601 was transmitted to, in Step 2506, the database operation command control module 1806 generates data to be transmitted to the server apparatus 101 based on the operation result data stored in the database operation result buffer 1808. The processing performed in Step 2506 is referred to as database operation result generation processing. As the database operation result generation processing, there are processing for connecting the operation result data stored in the database operation result buffer 1808, processing for assigning header information and trailer information to be transmitted to the server apparatus 101, and processing for assigning an identifier to be associated with a database operation command received from the server apparatus 101.

In Step 2507, the database operation command control module 1806 transmits the database operation result generated in Step 2506 to the server apparatus 101.

Based on the processing described above, the database operation command control module 1806 divides one database operation command 701 in accordance with the number of flash modules 107 in the storage controller 105, generates the database operation distributed execution command(s) 2601, and causes the database operation circuit 109 in each flash module 107 to execute the operation. This enables processing to be quickly performed by executing the database operation in parallel on the data cached in the flash modules 107 in the storage controller 105.

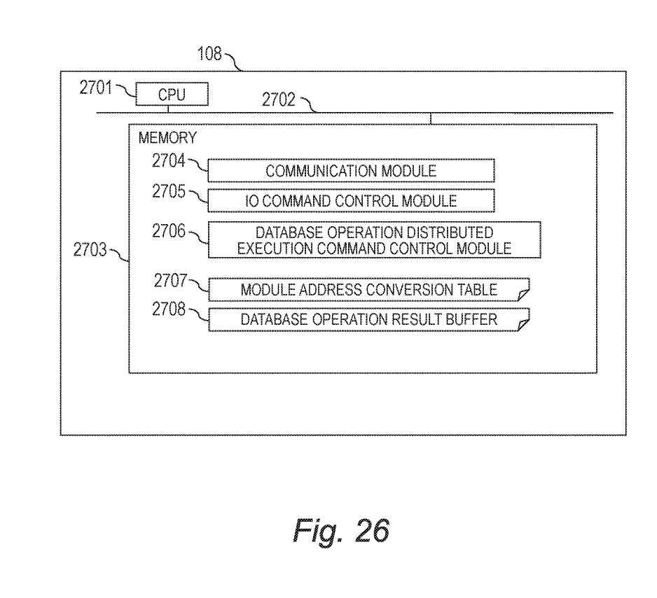

FIG. 26 is a block diagram for illustrating an example of the flash module controller 108. As illustrated in FIG. 26, the flash module controller 108 includes a CPU 2701, an internal network 2702, and a memory 2703. The CPU 2701 and the memory 2703 are coupled to each other by the internal network 2702.

A communication module 2704, an IO command control module 2705, and a database operation distributed execution command control module 2706 are stored in the memory 2703. The communication module 2704, the IO command control module 2705, and the database operation distributed execution command control module 2706 are programs executed by the CPU 2701. A module address conversion table 2707 and a database operation result buffer 2708 are also stored in the memory 2703.

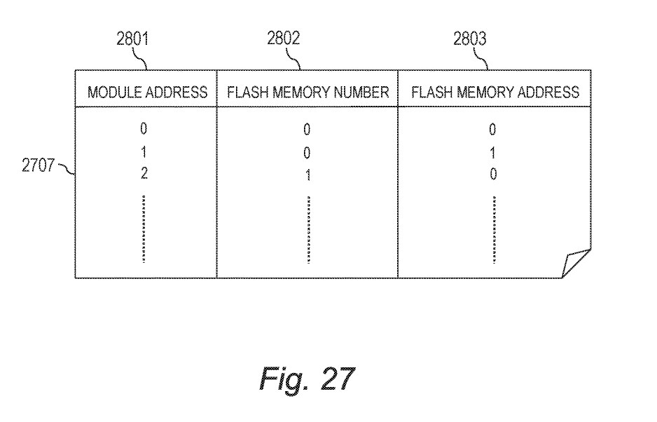

FIG. 27 is a diagram for showing information contained in the module address conversion table 2707 included in the flash module controller 108. As shown in FIG. 27, a module address 2801, a flash memory number 2802, and a flash memory address 2803 are stored in the module address conversion table 2707.

The module address 2801 represents the address to be used when the storage controller 105 reads and writes data stored in the flash modules 107.

The flash memory number 2802 represents a number for identifying the flash memories 110 of the flash modules 107. The flash memory address 2803 represents the address to be used when reading and writing the data stored in the flash memories 110.

In FIG. 26, the communication module 2704 in the flash module controller 108 is configured to transmit, when a command is received from the storage controller 105, the received command to the IO command control module 2705 when the command is an IO command.

The communication module 2704 in the flash module controller 108 is configured to transmit, when a command is received from the storage controller 105, the received command to the database operation distributed execution command control module 2706 when the command is the database operation distributed execution command 2601.

When an IO command is received from the communication module 2704, the IO command control module 2705 reads data from the flash memories 110 when the IO command is a READ command, and transmits the read data to the storage controller 105.

When an IO command is received from the communication module 2704, the IO command control module 2705 writes data to the flash memories 110 when the IO command is a WRITE command, and transmits a data write completion notification to the storage controller 105.

When the IO command control module 2705 is processing the command, the IO command control module 2705 refers to the module address conversion table 2707 to convert the module address 2801 into the flash memory address 2803, and reads and writes the data of the flash memories 110.

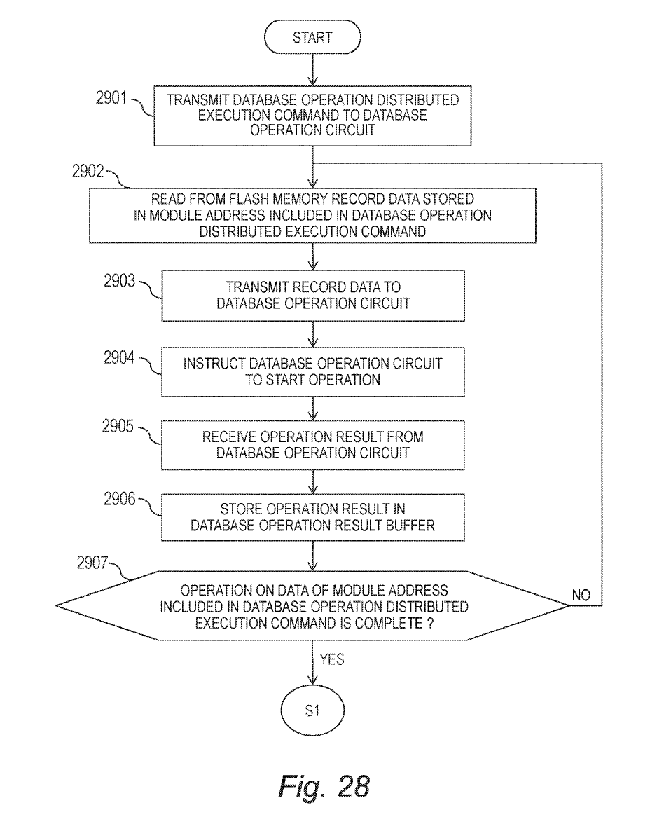

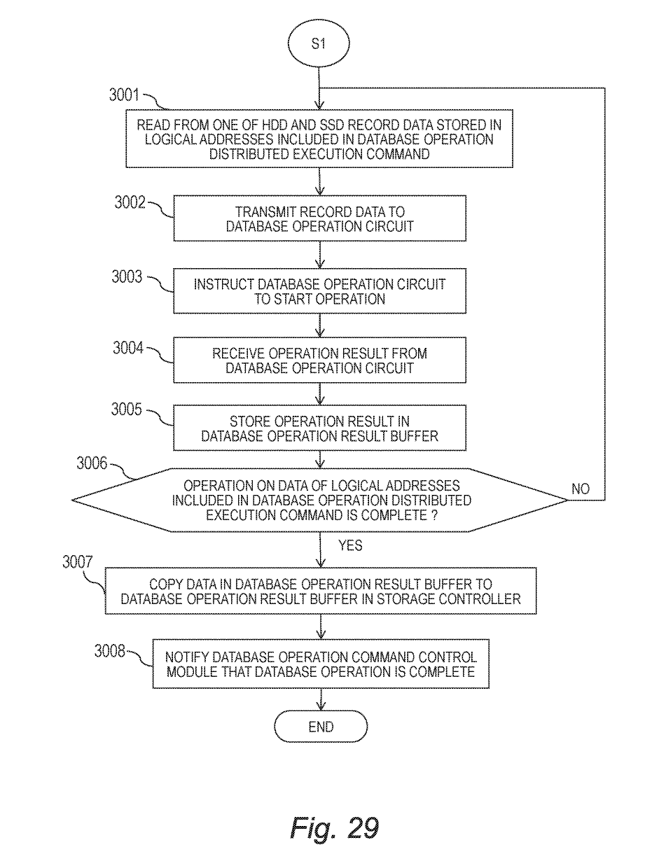

FIG. 28 and FIG. 29 are flowcharts for illustrating an example of processing performed by the database operation distributed execution command control module 2706. The database operation distributed execution command control module 2706 starts the processing when the database operation distributed execution command 2601 is received from the communication module 2704.

In Step 2901, the database operation distributed execution command control module 2706 transmits the received database operation distributed execution command 2601 to the database operation circuit 109.

In Step 2902, the database operation distributed execution command control module 2706 reads from the flash memories 110 the record data stored in the module address included in the database operation distributed execution command 2601. In Step 2902, a database record length 2408, the database operation start module address 2602, and the database operation end module address 2603, which are included in the database operation distributed execution command 2601, are used.

In Step 2903, the database operation distributed execution command control module 2706 transmits the record data read in Step 2902 to the database operation circuit 109. In Step 2904, the database operation distributed execution command control module 2706 instructs the database operation circuit 109 to start the operation.

In Step 2905, the database operation distributed execution command control module 2706 receives an operation result from the database operation circuit 109. In Step 2906, the database operation distributed execution command control module 2706 stores the operation result received in Step 2905 in the database operation result buffer 2708.

In Step 2907, the database operation distributed execution command control module 2706 judges whether or not the operation of the module address stored in the database operation distributed execution command 2601 is complete. When it is judged in Step 2907 that the operation of the module address stored in the database operation distributed execution command 2601 is not complete, the database operation distributed execution command control module 2706 returns the processing to Step 2902, and repeats the processing described above. In this case, in Step 2902, the record data from the next address of the address read from the flash memories 110 the previous time is read.

On the other hand, when it is judged in Step 2907 that the operation of the module address stored in the database operation distributed execution command 2601 is complete, the database operation distributed execution command control module 2706 executes Step 3001 illustrated in FIG. 29.

In Step 3001, the database operation distributed execution command control module 2706 reads from one of the HDD 111 and the SSD 112 the record data stored in the logical addresses (2604, 2605) of the database operation distributed execution command 2601.

In Step 3001, the database operation distributed execution command control module 2706 reads the record data from one of the HDD 111 and the SSD 112 by transmitting a READ command including the logical address of the data to be read and the database record length 708 to the IO command control module 205 in the storage controller 105.

In Step 3002, the database operation distributed execution command control module 2706 transmits the records data read in Step 3001 to the database operation circuit 109. In Step 3003, the database operation distributed execution command control module 2706 instructs the database operation circuit 109 to start the operation.

In Step 3004, the database operation distributed execution command control module 2706 receives an operation result from the database operation circuit 109. In Step 3005, the database operation distributed execution command control module 2706 stores the operation result received in Step 3004 in the database operation result buffer 2708.

In Step 3006, the database operation distributed execution command control module 2706 judges whether or not the database operation on the data of the logical addresses stored in the database operation distributed execution command 2601 is complete. When it is judged in Step 3006 that the database operation is not complete, the database operation distributed execution command control module 2706 returns the processing to Step 3001, and repeats the processing described above. In this case, in Step 3001, the database operation distributed execution command control module 2706 reads the record data from the next logical address of the logical address read the previous time.

On the other hand, when it is judged in Step 3006 that the database operation is complete, in Step 3007, the database operation distributed execution command control module 2706 copies the data in the database operation result buffer 2708 to the database operation result buffer 1808 in the storage controller 105. When copying to the database operation result buffer 1808, the data in the database operation result buffer 1808 is copied to the database operation result buffer address 2606 included in the database operation distributed execution command 2601.

In Step 3008, the database operation distributed execution command control module 2706 notifies the database operation command control module 1806 that the database operation is complete.

Based on the processing described above, operation target data stored in one of the HDD 111 and the SSD 112 may be cached in the flash modules 107. Further, one database operation command 701 may be divided into a plurality of database operation distributed execution commands 2601, and database processing may be executed in parallel by a plurality of flash modules 107.

The database operation command control module 1806 is capable of executing Step 2501 such that a load on the flash modules 107 is equalized. In this case, in Step 2501 illustrated in FIG. 24, the database operation command control module 1806 equalizes the load on the flash modules 107 based on a data amount and a number of search conditions, or based on the data amount to be read from the HDD 111 and the SSD 112.

The load amount on the flash modules 107 may be calculated based on the amount of data to be operated in the database operation distributed execution commands 2601 and the number of search conditions that are being executed, or are planned on being executed, by the flash modules 107. For example, the load amount on the flash modules 107 may be calculated by multiplying the data amount and the number of search conditions.

The load amount on the flash modules 107 may also be predicted based on the data amount to be read from the HDD 111 and the SSD 112 in the database operation command 701 that is being executed, or is planned on being executed, by the flash modules 107.

Based on the calculated load amounts, the database operation distributed execution commands 2601 having a small load amount are generated for the flash modules 107 having a large load amount, and the database operation distributed execution commands 2601 having a large load amount are generated for the flash modules 107 having a small load amount.

The database operation command control module 1806 is also capable of minimizing the data amount to be read from the HDD 111 and the SSD 112 by referring to the cache control module 1809 and assigning the database operation to be executed on the data stored in the flash module 107 to that flash module 107.

Thus, according to the third embodiment, a database operation may be executed more quickly by performing the operation in parallel on data cached in the flash modules 107. Further, the database operation command control module 1806 is capable of equalizing the load among the flash modules 107 by changing the processing (database operation distributed execution commands 2601) assigned to each flash module 107 in accordance with the load on each flash module 107.

As a result, a second object of this invention, namely, improving processing performance, may be achieved by causing the database operation function included in each of the flash modules 107 to be executed in parallel. In the above-mentioned related art, one flash module including a database operation function is executed on one processing request from the server apparatus. As a result, the database operation function processing performance of the related art is limited by the database processing function that the one flash module has. In contrast, in the third embodiment, the database operation is executed in parallel in accordance with the number of flash modules 107 arranged in one storage controller 105, which enables the processing performance to be improved.

It is a third object of this invention to quickly execute the database operation on data that is frequently used in the storage apparatus. In view of this, in the third embodiment, the database operation is executed on data cached in the flash modules 107, which enables the database operation to be executed more quickly for frequently used data.

The computers, processing units, and processing means described related to this invention may be, for a part or all of them, implemented by dedicated hardware.

The variety of software exemplified in the embodiments can be stored in various media (for example, non-transitory storage media), such as electro-magnetic media, electronic media, and optical media and can be downloaded to a computer through communication network such as the Internet.

This invention is not limited to the foregoing embodiments but includes various modifications. For example, the foregoing embodiments have been provided to explain this invention to be easily understood; they are not limited to the configurations including all the described elements.

What is claimed is:

1. A storage apparatus to be coupled to a network, the storage apparatus comprising:
a controller; and
a storage medium to be coupled to the controller,
the storage medium comprising one or more flash modules each comprising a database operation module,
the controller being configured to receive a database operation command, and to cause the one or more flash modules to execute the received database operation command.

2. The storage apparatus according to claim 1, wherein the controller is configured to:
generate, based on the received database operation command, a database operation drive command to be transmitted to the one or more flash modules;
transmit the generated database operation drive command to the one or more flash modules;
receive an execution result of the database operation drive command from the one or more flash modules; and
output the received execution result.

3. The storage apparatus according to claim 1,
wherein the storage medium comprises a second storage medium configured to store data in addition to the one or more flash modules, and
wherein each of the one or more flash modules is configured to issue, when executing a database operation on the data stored in the second storage medium, a request to the controller for the data in the second storage medium, and to execute the database operation after the data in the second storage medium received from the controller has been read.

4. A storage apparatus to be coupled to a network, the storage apparatus comprising:
a controller; and
a storage medium to be coupled to the controller,
the controller comprising, as a cache, one or more flash modules each comprising a database operation module,
the controller being configured to receive a database operation command and to cause the one or more flash modules to execute the received database operation command on data cached in the one or more flash modules.

5. The storage apparatus according to claim 4, wherein the controller is configured to:
generate, based on the received database operation command, a database operation drive command to be transmitted to the one or more flash modules;
transmit the generated database operation drive command to the one or more flash modules;
receive an execution result of the database operation drive command from the one or more flash modules; and
output the received execution result.

6. The storage apparatus according to claim 4, wherein the controller is configured to:
divide the received database operation command in accordance with a number of the one or more flash modules;
generate a database operation distributed execution command to be transmitted to each of the one or more flash modules;
transmit the generated database operation distributed execution command to each of the one or more flash modules;
cause each of the one or more flash modules to execute in parallel the transmitted database operation distributed execution command;
receive an execution result of the database operation distributed execution command from each of the one or more flash modules; and
collectively output the received execution result.

7. The storage apparatus according to claim 4,
wherein the storage medium comprises a second storage medium configured to store the data, and
wherein the controller is configured to read, when executing a database operation on the data stored in the second storage medium, the data from the second storage medium, and to execute the database operation after the read data is stored in the cache.

8. A computer system, comprising:
a server apparatus to be coupled to a network; and
a storage apparatus to be coupled to the server apparatus via the network,
the storage apparatus comprising:
a controller; and
a storage medium to be coupled to the controller,
the storage medium comprising one or more flash modules each comprising a database operation module,
the controller being configured to receive a database operation command from the server apparatus, and to cause the one or more flash modules to execute the received database operation command.

9. The computer system according to claim 8, wherein the controller is configured to:
generate, based on the received database operation command, a database operation drive command to be transmitted to the one or more flash modules;
transmit the generated database operation drive command to the one or more flash modules;
receive an execution result of the database operation drive command from the one or more flash modules; and
output the received execution result.

10. A computer system, comprising:
a server apparatus to be coupled to a network; and
a storage apparatus to be coupled to the server apparatus via the network,
the storage apparatus comprising:
a controller; and
a storage medium to be coupled to the controller,
the controller comprising, as a cache, one or more flash modules each comprising a database operation module,
the controller being configured to receive a database operation command from the server apparatus, and to cause the one or more flash modules to execute the received database operation command on data cached in the one or more flash modules.

11. The computer system according to claim 10, wherein the controller is configured to:
generate, based on the received database operation command, a database operation drive command to be transmitted to the one or more flash modules;
transmit the generated database operation drive command to the one or more flash modules;
receive an execution result of the database operation drive command from the one or more flash modules; and
output the received execution result to the server apparatus.

12. The computer system according to claim 10, wherein the controller is configured to:
divide the received database operation command in accordance with a number of the one or more flash modules;
generate a database operation distributed execution command to be transmitted to each of the one or more flash modules;
transmit the generated database operation distributed execution command to each of the one or more flash modules;
cause each of the one or more flash modules to execute in parallel the transmitted database operation distributed execution command;
receive an execution result of the database operation distributed execution command from each of the one or more flash modules; and
collectively output the received execution result to the server apparatus.

13. The computer system according to claim 10,
wherein the storage medium comprises a second storage medium configured to store the data, and
wherein the controller is configured to read, when executing a database operation on the data stored in the second storage medium, the data from the second storage medium, and to execute the database operation after the read data is stored in the cache.

14. A flash module, comprising:
a flash memory; and
a database operation module,
the database operation module being configured to:
receive a database operation command;
execute the received database operation command on data stored in the flash module; and
issue, when the data is not stored in the flash module, a request for the data to a higher-level apparatus.
